(19) United States
(12) Patent Application Publication
(10) Pub. No.: US 2013/0235028 A1
(43) Pub. Date: Sep. 12, 2013

(54) Non-photorealistic Rendering of Geographic Features in a Map

(71) Applicants: Peter W. Giencke, Mountain View, CA (US); Guirong Zhou, Mountain View, CA (US)

(72) Inventors: Peter W. Giencke, Mountain View, CA (US); Guirong Zhou, Mountain View, CA (US)

(73) Assignee: Google Inc., Mountain View, CA (US)

(21) Appl. No.: 13/414,504

(22) Filed: Mar. 7, 2012

(51) Int. Cl. G06T 15/00

(52) U.S. Cl. 345/419

(57) ABSTRACT

Generating non-photorealistic renderings of geographic features for a map that emphasize one or more geographic features in the rendering while de-emphasizing other portions of the rendering. Three dimensional geographic model data is stored for a plurality of geographic features. Portions of the model data representing a geographic feature and its surrounding area are selected. A non-photorealistic rendering is generated from the model data. The geographic feature is rendered with greater visual emphasis than the portions of the data that surround the geographic feature, and the resulting rendering is output for display.

### FIELD OF THE INVENTION

Described embodiments relate generally to non-photorealistic rendering of online maps, and more specifically to non-photorealistic rendering of geographic features in online maps.

### BACKGROUND

Online maps are typically rendered in two-dimensional or pseudo-3D projections. Two-dimensional projections, such as conic, cylindrical, azimuthal, typically show a geographic area in a plan or “bird's eye” view, while pseudo-3D projections show the geographic area using perspective and similar methods. In two-dimensional projections, geographic features in an area often simply labeled with a text label such “Empire State Building” without any distinguishing visual appearance. However, the visual appearance of a geographic feature is difficult to convey in text. Additionally, reading a large amount of text on a heavily labeled map requires additional effort on the part of the user. In pseudo-3D projections, geographic features are typically rendered in photo-realistic detail, sometimes using actual photographs to identify the feature. However, photographs may only be available for a limited number of features that are taken from a limited number of perspectives. In addition, photographs often include extraneous information that makes it difficult to identify the particular feature from the photograph itself. In either approach, the projection of the map does not necessarily convey to the user the salience or importance of a geographic feature to the user's request for the map.

### SUMMARY

Disclosed embodiments generate non-photorealistic renderings of geographic features in a map that emphasize certain geographic features in the rendering while de-emphasizing other features of the rendering. In one embodiment, a rendering system stores three dimensional (3D) geographic model data for a multitude of geographic features. For example, the data may include building models and terrain elevation data for both natural features (e.g. mountains) and artificial features (e.g. buildings). The system selects a portion of the model data that represents a particular geographic feature to be included in a map view. The system also selects a portion of the model data (e.g., representing other geographic features) from an area that surrounds the geographic feature. Each portion of the model data is rendered according to a set of rendering parameter settings such the selected geographic feature is emphasized in the resulting non-photorealistic rendering, while the area surrounding the selected geographic feature is de-emphasized. The non-photorealistic rendering is then provided for display. The resulting image provides a user with visual information about the appearance of a select geographic feature and its surroundings while also drawing the user's attention to the geographic feature.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a computing environment for a geographic rendering system, according to one embodiment.

FIG. 2 is a method for generating a non-photorealistic image, according to an embodiment.

FIG. 3 is more detailed view the step of generating a non-photorealistic rendering from FIG. 2, according to an embodiment.

FIG. 4A is a non-photorealistic rendering, according to one embodiment.

FIG. 4B is user interface that includes the non-photorealistic rendering of FIG. 4A, according to one embodiment.

FIG. 5 is a non-photorealistic rendering, according to one embodiment.

FIG. 6 is a user interface that includes a non-photorealistic rendering, according to one embodiment.

The figures depict a preferred embodiment of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

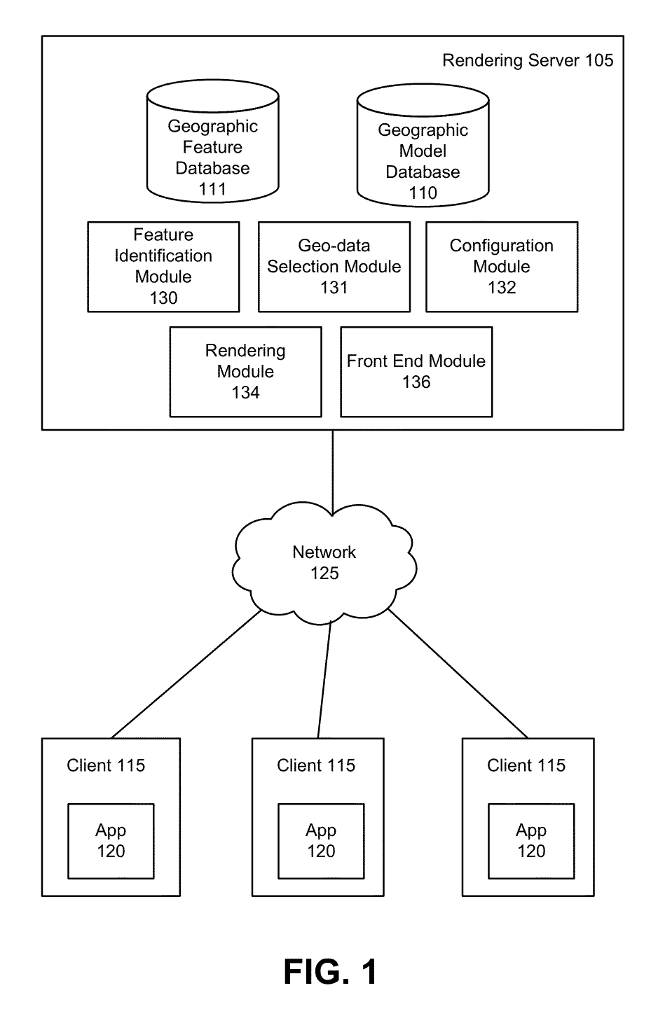

FIG. 1 is a computing environment for a geographic rendering system, according to one embodiment. The computing environment includes a rendering server 105 connected to a number of clients 115 through a network 125. The rendering server 105 includes functionality for generating a non-photorealistic rendering (NPR) that emphasizes important features in the rendered image while de-emphasizing other parts of the rendered image. As used herein, NPR refers to an area of computer graphics that employs a wide variety of expressive styles for rendering digital images. NPR is inspired by artistic styles such as painting, drawing, technical illustration and animated cartoons. NPR images can be rendered in a manner that includes abstraction and artistic stylization that are visually comparable to renderings produced by a human artist.

In one embodiment, the rendering server 105 renders particular geographic features (“features of interest”) with greater emphasis than other features in the image to draw the user's attention to the features of interest. The feature of interest may be rendered in a style that is pseudo-photorealistic and appears with a high level of realism, whereas other portions of the image are rendered in a style that is much less realistic. A geographic feature refers to any component of the Earth. Geographic features may be natural geographic features or artificial geographic features. Natural geographic features include features such as bodies of water, mountains, deserts and forests. Artificial geographic features include man-made constructs such as cities, buildings, roads, dams and airports.

In one embodiment, the rendering server 105 is implemented as a server class computer comprising a CPU, memory, network interface, peripheral interfaces, and other well known components. As is known to one skilled in the art, other types of computers can be used which have different architectures. The server 105 can be implemented on either a single computer, or using multiple computers networked together. The server 105 is also adapted to execute computer program modules for providing functionality described herein. As used herein, the term “module” refers to computer program logic used to provide the specified functionality. Thus, a module can be implemented in hardware, firmware, and/or software. In one embodiment, program modules are stored in a non-transitory computer-readable storage medium (e.g. RAM, hard disk, or optical/magnetic media) and executed by a processor or can be provided from computer program products that are stored in non-transitory computer-readable storage mediums.

As shown in FIG. 1, the rendering server 105 includes a geographic model database 110, a geographic feature database 111, a feature selection module 130, a geo-data selection module 131, a parameter module 132, a rendering module 134 and a front end module 136. In general, functions described in one embodiment as being performed on the server 105 side can also be performed on the client 115 side in other embodiments if appropriate. In addition, the functionality attributed to a particular component can be performed by different or multiple components operating together.

The geographic model database 110 includes geographic model data (“geo-data”) that can be used to generate NPRs for portions of the world. The geo-data includes three dimensional (3D) terrain elevation data covering all of or a portion of the world. The geo-data may also include 3D models for specific geographic features, such as buildings, bridges, monuments, roads and the like. Some of the 3D models may be extremely detailed, whereas other 3D models may include less detail and include, for example, just a basic outline of the geographic feature represented by the 3D model.

The geographic feature database 111 includes a list of geographic features that can be rendered by the rendering server 105. Each geographic feature is associated with a geographic location (e.g., geographic coordinates, geo-code, or address) that can be used to identify the portion of the geo-data that represents the geographic feature. The feature database 110 can be used in conjunction with the geo-data in the geographic model database 110 to create a NPR that emphasizes a feature of interest in the resulting rendering while de-emphasizing other features in the rendering.

Geographic model database 110 and feature database 111 are illustrated as being stored in server 105. Alternatively, many other configurations are possible. The databases do not need to be physically located within server 105. For example, the databases can be stored in a client 115, in external storage attached to server 105, or in network attached storage. Additionally, there may be multiple servers 105 that connect to the databases.

The feature identification module 132 receives selection inputs from the client devices 115 via the front end module 136. The selection inputs may be search queries or any other type of input that can be used to identify a geographic feature that is of interest to a user of the client device 115. From the selection input, the feature selection module 132 accesses the feature database 111 to identify a geographic feature of interest that corresponds to the selection input and information about the location of the feature of interest, and is one means for performing this function. The feature identification module 132 may also analyze other types of information in identifying the feature of interest, such as a location of a client device 115, social data generated by the client devices 115, and the prior search history of a user of a client device 115.

Given a feature of interest, the geo-data selection module 132 is configured to access the geographic model database 110 to select portions of the geo-data for rendering, and is one means for performing this function. Some selected portions of the geo-data are representative of the feature of interest. Other selected portions of the geo-data are representative of the area or features surrounding the feature of interest. The amount of geo-data selected may be configured, for example, according to a desired zoom level of the resulting NPR image.

The configuration module 132 configures rendering parameters for the selected portions of the geo-data, and is one means for performing this function. The portion of the geo-data representing the feature of interest is associated with a set of rendering parameters that result in a high level of visual emphasis. The other portions of the geo-data are associated with rendering parameters that result in a lower level of visual emphasis. In some embodiments, the configuration module 132 communicates with the client devices 115 via the front end module 136 to obtain information from the client devices 115, such as the location of or orientation of the client device. The rendering module 134 may have access to global weather data or global time information that can be used to determine the weather conditions or time at a physical location of a geographic feature. This information, along with other types of information, can be used to adjust rendering settings that affect the final appearance of the rendered image generated by the rendering module 134.

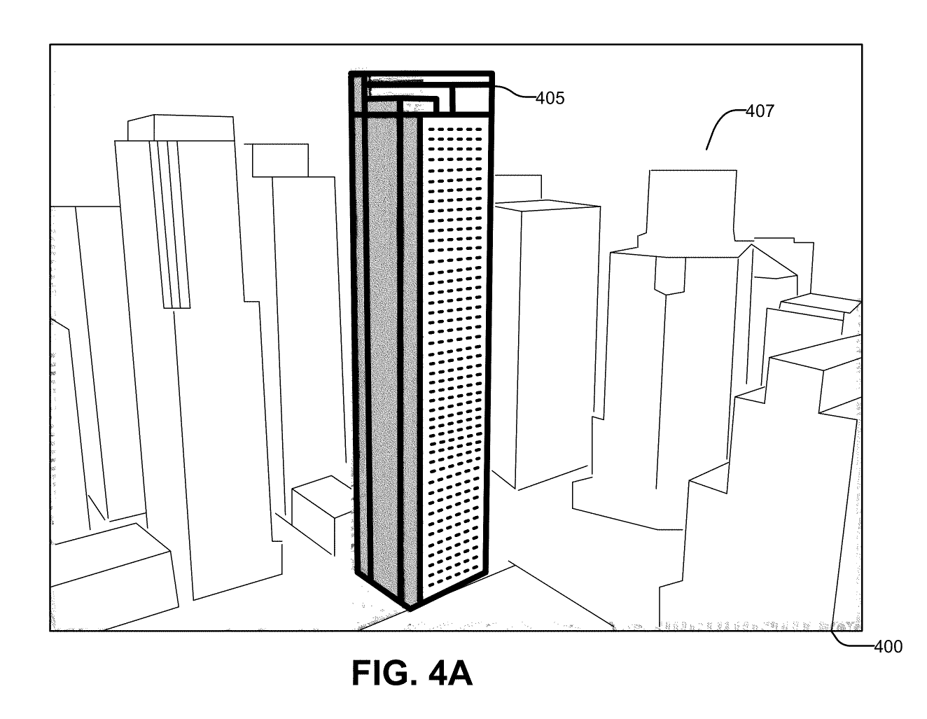

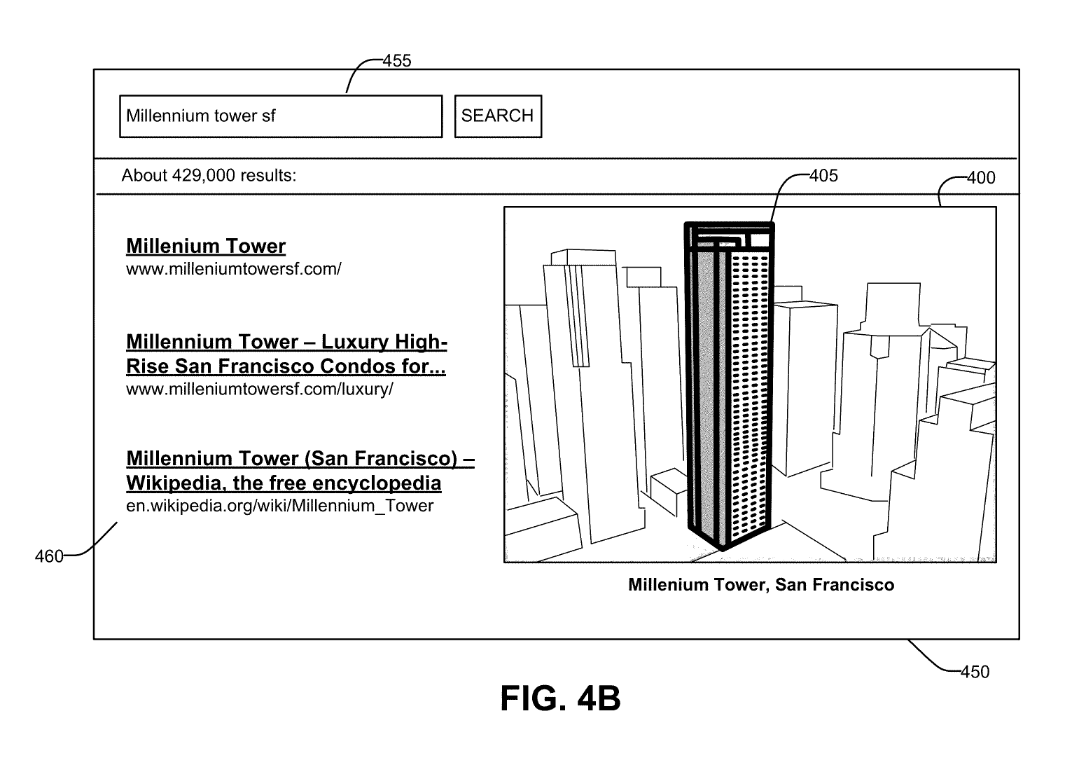

The rendering module 134 accesses the geographic model database 110 to obtain geo-data that is needed to render an image of the feature of interest and its surroundings. The rendering module 134 then renders a 2D NPR image from this geo-data using the different sets of rendering parameters that create different rendering styles, and is one means for performing this function. As a result, some portions of the geo-data that represent the feature of interest are emphasized to draw the user's attention to these portions. Other portions of the geo-data are de-emphasized but still included in the NPR image to provide context for the feature of interest. The rendered image is then provided to the front end-module 136, which in turn provides the rendered image to the requesting client device 115. Examples of NPRs are illustrated in FIGS. 4A, 4B, 5 and 6.

The front end module 136 handles communications with the client devices 115, and is one means for performing this function. The front end module 136 receives selection inputs from the clients 115 and relays them to the feature identification module 130. The front end module 136 also receives rendered images from the rendering module 134, formats them into the appropriate format (e.g., HTML or otherwise) and provides the rendered images to the clients 115 for display to a user of the client 115.

In one embodiment, a client 115 executing an application 120 connects to the rendering server 105 via the network 125 to retrieve a NPR generated by the rendering server 105. The client devices 115 may have location sensors (e.g., GPS) generating location data that is provided to the rendering server 105. The client devices may also have orientation sensors that generate orientation data that is provided to the rendering server 105.

The network includes but is not limited to any combination of a LAN, MAN, WAN, mobile, wired or wireless network, a private network, or a virtual private network. While only three clients 115 are shown in FIG. 1, in general very large numbers (e.g., millions) of clients 115 are supported and can be in communication with the map server 105 at any time. In one embodiment, the client 115 can be implemented using any of a variety of different computing devices, some examples of which are personal computers, digital assistants, personal digital assistants, mobile phones, smart phones, tablet computers and laptop computers.

The application 120 is any application suitable for requesting and displaying geographic information and maps. The application may be a browser such as GOOGLE CHROME, MICROSOFT INTERNET EXPLORER, NETSCAPE NAVIGATOR, MOZILLA FIREFOX, and APPLE SAFARI. Alternatively, the application may be a dedicated map application, such as Google Maps™. The application 120 is capable of receiving user inputs from a user of the client device 115 and displaying a NPR retrieved from the rendering server 105.

### Non-Photorealistic Rendering of Geographic Features

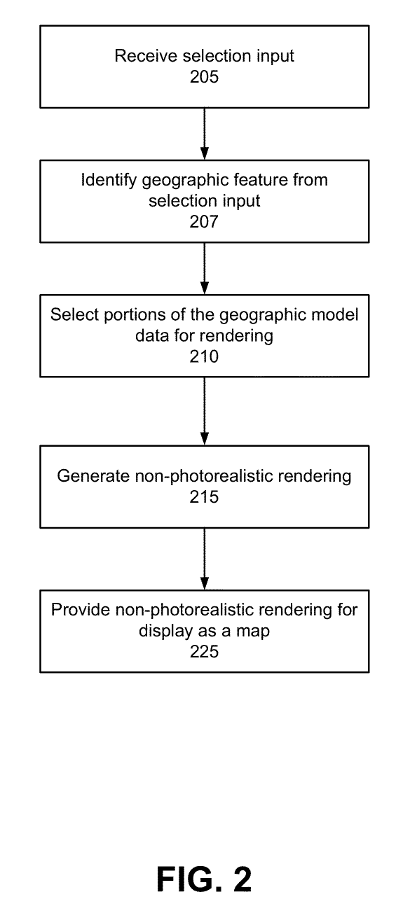

FIG. 2 is a method for generating a NPR of geographic features, according to an embodiment of the rendering server 105. In step 205, a selection input for a geographic feature is received from a client device 115. A selection input is any type of input that can be processed for identifying a geographic feature of interest. For example, the selection input may in the form of a text query for “Wrigley Field chicago” that is generated by a user of the client device 115.

In step 207, one or more geographic features are identified from the selection input. Continuing the above example, because the query is for “Wrigley Field chicago” the Wrigley Field baseball stadium in Chicago is identified as the feature of interest. In one embodiment, search scores may be calculated for different geographic features that indicate how relevant the geographic features are to the selection input. The geographic feature with the highest search score is then identified as the geographic feature of interest. In one embodiment, a number of different indicia for the feature of interest can be used in calculating the search scores, examples of which are provided below. The indicia may be combined or used individually in calculating the search scores.

In one embodiment, the text of a search query can be matched to the names of geographic features in calculating the search scores. Close matches increase the score for a geographic feature while non-matches do not affect the score. For example, if the search query is for “Wrigley Field chicago”, which partially matches the text in the name of the Wrigley Field baseball stadium, the search score for the Wrigley Field baseball stadium may be increased to indicate that a good match exists.

The user's search history can be analyzed to determine if the terms in the user's search history are terms that are related to a common geographic feature. If a relationship exists between a prior search term and a geographic feature, the search score of the geographic feature is increased. For example, if the user's search history includes searches for “baseball game”, “bars near Wrigley”, and “Wrigleyville”, it can be determined that these terms are all related to the Wrigley Field baseball stadium, which increases the search score for Wrigley Field baseball stadium.

Ambient social information provided by other users or client devices can also be analyzed in computing the search scores. Ambient social information includes, for example, messages and other information broadcast through a social networking service (e.g., TWITTER tweets, FACEBOOK posts, GOOGLE+ posts, FOURSQUARE checkins) If the social data indicates that a particular topic is trending, the search score for that geographic topic can be increased accordingly. For example, if social information generated by a social networking service within the last 30 minutes indicates that “Cubs” and “Wrigley” are two popular topics, the search score for the Wrigley Field baseball stadium would be increased because both topics are related to Wrigley Field. The ambient social information may be weighted by time such that only recent social information affects the search score while older social information does not affect the search score.

The location of a user or client device may be used as an additional factor in computing the search scores. As the distance between the client device and a geographic feature decreases, the search score for that geographic feature also increases. For example, if the user is searching for “baseball stadium” and the user's client device indicates that the user is only 300 meters from Wrigley Field in Chicago, the search score for Wrigley Field would be increased due to the close distance between the user and Wrigley Field.

In step 210, several portions of the geo-data in the geographic model database 110 are selected for rendering. In one embodiment, a first portion of the geo-data is selected that represents a feature of interest (i.e. the feature identified in step 207). If the geographic feature is a building at a particular location, the portion of the geo-data selected by the rendering module may be a building model for the geographic feature. For example, continuing with the above example, if the geographic feature is Wrigley Field, the selected portion of the model data is the 3D building model for Wrigley field.

In one embodiment, the portion of the geo-data representing the feature of interest includes geo-data that is within a “focus radius” of a location of the feature of interest. For example, if the geographic feature is Half-Dome at Yosemite National Park, the focus radius may be any portions of the terrain data that are within 100 meters of the latitude and longitude coordinates of Half-Dome. The focus radius may be set to a pre-determined distance, or set in accordance with a user input defining the size of the focus radius.

Other portions of the geo-data that are in the area adjacent to or surrounding the feature of interest are also selected for rendering (“secondary portions”). The secondary portions of the geo-data can include geographic features that are less relevant than the feature of interest, but are selected for rendering to provide additional context for the feature of interest. Continuing with the above example, if the geographic feature is Wrigley Field, the secondary portions of the geo-data that are selected in step 320 may include buildings, such as bars and restaurants, that are adjacent to Wrigley Field.

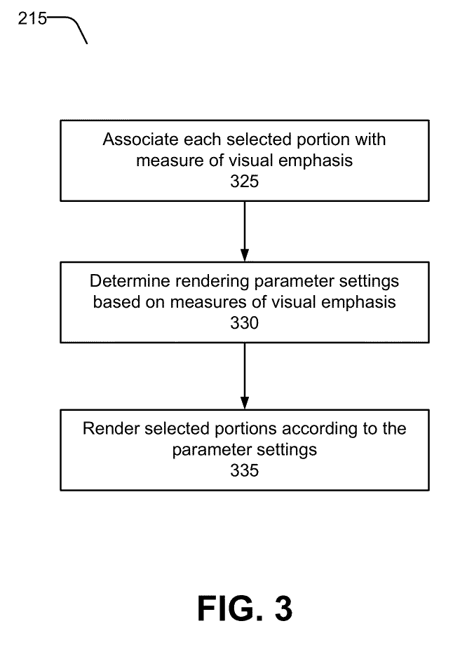

In step 215, a NPR image is generated from the selected portions of the geo-data. The portion of the geo-data representing the feature of interest is rendered in a more realistic rendering style than the secondary portions of the geo-data. Rendering different portions of the geo-data in different rendering styles allows greater emphasis to be placed on features that are relevant to the user's selection while de-emphasizing the less relevant features. Step 215 is explained in greater detail in conjunction with FIG. 3.

In step 225, the NPR image is provided for display. The NPR image may be output for display to the client device that provided the selection input which caused the rendering server 105 to generate the NPR image. When displayed on the client device, a user of the client device is thus provided with information about a geographic feature that is of interest to the user and additional contextual information about the area that surrounds the feature of interest. The NPR image can be combined with other information (e.g., routing information, descriptions, legends, etc.) and output together with that information as part of a user interface (e.g., a webpage).

FIG. 3 is more detailed view of step 215 from FIG. 2, according to one embodiment. At this point in the process, different portions of the geo-data have been selected for rendering. In step 325, each selected portion of the geo-data is associated with its own measure of visual emphasis. The measure of visual emphasis indicates how much emphasis or “focus” should be placed on a portion of the geo-data when it is rendered. In one embodiment, the portion of the geo-data representing the geographic feature of interest is associated with a high level of visual emphasis, whereas the secondary portion of the geo-data that does not represent the feature of interest is associated with a lower level of visual emphasis. The higher level of visual emphasis indicates that the geographic feature of interest will be more prominent in the resulting NPR image than its surrounding features. Continuing with the previous example, the portion of the geo-data representing Wrigley Field is associated with a high level of visual emphasis, whereas the buildings surrounding Wrigley Field are associated with a low level of visual emphasis.

In one embodiment, there are many different levels of visual emphasis that can be associated with the geo-data, and the user can manually adjust the baseline level of visual emphasis for the geographic features of interest. For example, the user can be presented with a “reality slider” or “reality knob” in a user interface for viewing a NPR image. The user sets the appropriate reality settings. The rendering server 105 sets the level of visual emphasis of the feature of interest and/or the other portions of the NPR in accordance with the user defined settings, such that a high value of the setting results in a more photorealistic rendering of the geographic feature, and a low value of the setting results in less photorealistic, more expressive rendering of the geographic feature. The level of visual emphasis for the secondary portions of the geo-data is then determined relative to the user's baseline setting.

In one embodiment, the secondary portions of the geo-data can be further sub-divided into sub-portions. Each sub-portion is associated with a different level of visual emphasis to create a visual transition in the NPR image between the feature of interest and the remaining portions of the image. The sub-portion of the geo-data that is furthest from the feature of interest is associated with a low level of visual emphasis. Sub-portions that are closer to the feature of interest are associated with increasingly higher levels of visual emphasis to create a visual transition between the low level of visual emphasis and the high level of visual emphasis at the geographic feature of interest.

In step 330, settings for rendering parameters are determined for each selected portion of the geo-data as a function of the measures of visual emphasis. Rendering parameters are filters that control the appearance of a rendered image. Examples of rendering parameters include: stroke width, transparency, color, color saturation, detail level, texture, shadow, and blur. This list is not exhaustive, and other rendering parameters are also possible. Rendering parameters can take on different settings depending on the desired level of visual emphasis. For instance, when a high level of emphasis is desired, the geo-data can be rendered with a high level of detail. When a medium level of emphasis needed, the geo-data can be rendered with a medium level of detail. When a low level of emphasis is needed, the geo-data can be rendered with a low level of detail. Several rendering parameters and possible settings for those parameters are summarized briefly in the following table.

| Parameter | High Emphasis | Low Emphasis |
|---|---|---|
| Stroke width | Thick lines | Thin lines |
| Transparency | Opaque | Transparent |
| Color | RGB | Black and White |
| Color Saturation | Saturated | De-saturated |
| Detail Level | High detail | Low detail |
| Texture | Rich | Minimal |
| Shadow | Shadow on | Shadow off |
| Blur | No blur | High blur |

The rendering parameters for a portion of the geo-data can be determined based upon the measure of visual emphasis associated with it. In one embodiment, each measure of visual emphasis may be pre-configured to have a given set of baseline parameter settings. For instance, a high level of visual emphasis may be pre-configured to have parameter settings for thick lines and the use of color. A low level of visual emphasis may be pre-configured to have parameter settings for thin lines and a lack of color. Continuing with the previous example, the portion of the geo-data representing Wrigley Field is assigned parameter settings that are consistent with a high level of visual emphasis. The buildings surrounding Wrigley Field are assigned parameter settings that are consistent with a lower level of visual emphasis.

The baseline settings for the rendering parameters may also be adjusted according to environmental factors such as a time of day or weather conditions. In one embodiment, the time of day is determined at a location of geographic feature of interest. The baseline rendering settings are then adjusted so that the appearance of the rendering is consistent with the current time. For example, if the geographic feature of interest is Wrigley Field and the current time in Chicago is in the late afternoon (e.g., 5-6 pm), the color parameter may be adjusted so that the resulting image appears with a reddish hue to indicate that the sun is setting.

In one embodiment, the weather conditions are determined at the location of the geographic feature of interest. Weather conditions may be determined, for example, by querying a weather database that contains weather information for different locations around the world. The rendering parameters are adjusted so that the appearance of the rendering is consistent with the present weather conditions. For example, if the geographic feature of interest is the Wrigley Field and the current time in Chicago is overcast, the rendering color saturation parameter may be adjusted so that the resulting image appears with muted colors.

In step 335, the selected portions of the geo-data are rendered in accordance with the rendering parameters. The portion of the geo-data representing the feature of interest is rendered according to its own parameters, while the secondary portions of the geo-data are rendered according to their own parameters. The resulting image thus places greater visual emphasis on the portion of the image representing the geographic feature of interest, while de-emphasizing other portions of the image. Still continuing with the same example, Wrigley Field would be rendered with parameter settings that result in a high level of visual emphasis. The buildings surrounding Wrigley Field would be rendered with parameter settings that result in a lower level of visual emphasis. In some embodiments, higher level of visual emphasis result in a more photorealistic rendering than lower levels of visual emphasis.

The rendering may be generated from any of a number of different points of view. For example, the rendering may have a ground-level point of view or a point of view that is somewhere above ground-level (e.g. 100 meters above ground level). Additionally, the point of view of the rendered image may also be affected by the location and orientation of a client device that the image is being generated for (i.e., the client device that provided the selection input). In one embodiment, a location of the client device 115 that the NPR is being generated for is determined. If the client 115 is a mobile device, the client 115 may identify its location by using GPS data or other phone localization techniques and provide this location information to the rendering server 105. The rendering is then generated from the point of view of the client's 115 location. For example, if the geographic feature is the Eiffel tower and location of the client 115 indicates that the client 115 is one mile to the west of the Eiffel tower, the rendering of the Eiffel tower is generated from a point of view located one mile to the west of the Eiffel tower and facing towards the Eiffel tower.

In another embodiment, a vertical or horizontal orientation of the client device 115 that the rendering is being generated for is determined. The rendering is then generated to have a point of view that matches the orientation of the client device 115. For example, if the client device 115 is a mobile phone that is located at the base of the Eiffel tower that is tilted upwards toward the top of the Eiffel tower, the rendering is generated to have a point of view that is facing upwards towards the top of the Eiffel tower.

FIG. 4A is a NPR 400, according to one embodiment. Shown in the image 400 is the Millennium Tower 405, a building in San Francisco, and its surrounding buildings 407. The Millennium Tower 405 is the feature of interest and associated with a high level of visual emphasis. The Millennium Tower 405 is thus is rendered with thick lines, dark shading on one side of the building, and a high level of detail that includes the windows on one side of the tower 500. The remaining buildings 407 in the image 400 are associated with a low level of visual emphasis. The remaining buildings are thus rendered with thin lines, no shading, and a low level of detail. The inclusion of the surrounding buildings 407 in the NPR image 400 provides additional context for the Millennium tower 405. The contrast in rendering styles causes the Millennium Tower 405 to be more prominent in the image 400 and draws the user's attention to the Millennium Tower 405.

FIG. 4B is user interface 450 that includes the NPR 400 of FIG. 4A, according to one embodiment. The user interface 450 may be, for example, a webpage generated by the rendering server 105 that is displayed on the client device 115. The interface 450 includes a text box 455 for entering a user input in the form of a search query, a list of search results 460, and a NPR image 400. Here, the user has entered a search query for “Millennium tower sf.” The rendering server 105 receives the search query and determines that the search query refers to the Millennium Tower 405 located in San Francisco. The rendering server 105 renders the Millennium Tower 405 and the buildings surrounding the Millennium tower 405 into an image 400. The image 400 is then added to the interface 450 and presented in conjunction with several search results 460 to supplement the search results 460 with a map view of the Millennium Tower 405.

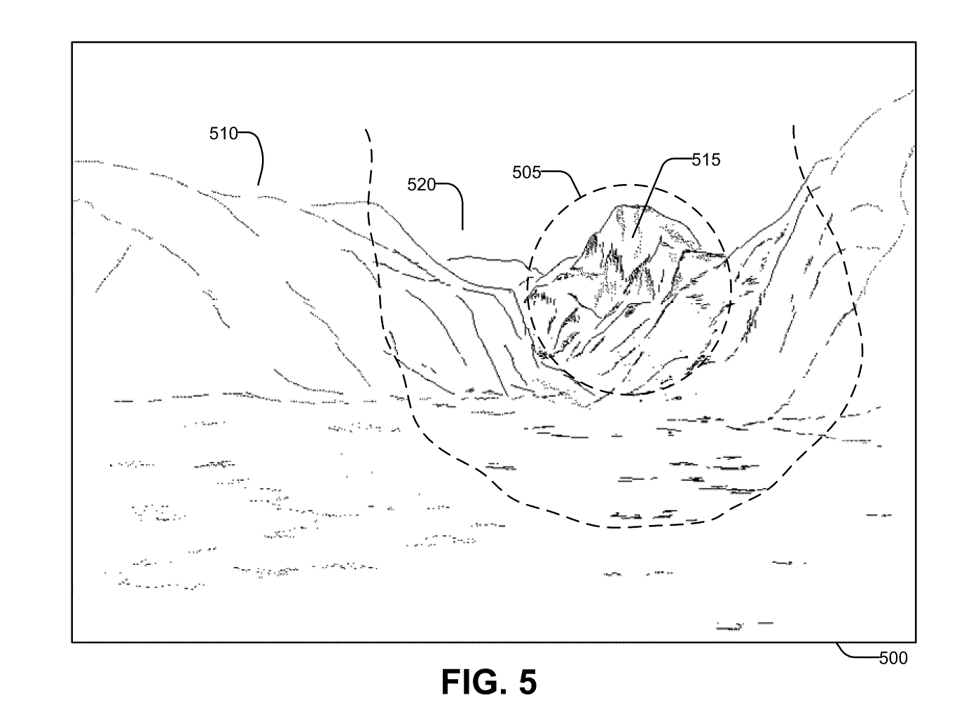

FIG. 5 is a NPR 500, according to one embodiment. Shown in the image 500 is a map view of Half Dome 515 from Yosemite National Park. The rendering may be generated for example in response to a search query for “half dome.” The geo-data used to generate the image 500, and also the image 500 itself, can be divided into three portions. Portion 505 represents Half Dome 515. Portion 510 and 520 are geo-data from the area surrounding Half Dome 515.

The portion 505 of the geo-data that represents Half Dome 515 is rendered in a different rendering style than the rest of the geo-data. Specifically, portion 505 is rendered with a higher level of detail than portions 510 and 520. As previously mentioned, other rendering techniques may also be used to emphasize a geographic feature, such as color, color saturation, line thickness, texture, transparency, or shadow. Rendering Half Dome 515 so that it stands out in the image 500 draws the user's attention to Half Dome 515 while still providing important information about the area that surrounds Half Dome 515.

Portion 510 and 520 are also rendered with different rendering styles. Portion 510 is rendered with very little detail and thin lines. Portion 520 is a transition region that is rendered with a medium level of detail and normal lines. Portion 520 is thus rendered in a style that blends the rendering style of 505 with the rendering style of portion 510 and allows for a visual transition between the rendering style of portion 505 and the rendering style of portion 510. In some embodiments, the transition region 520 is rendered in a manner that creates a gradual transition between the rendering style of portion 510 and portion 505. For example, the transition region 520 may gradually appear more like portion 505 in areas of the transition region 520 that are closer to portion 520, while appearing more like portion 510 in areas of the transition region 520 that are closer to portion 510.

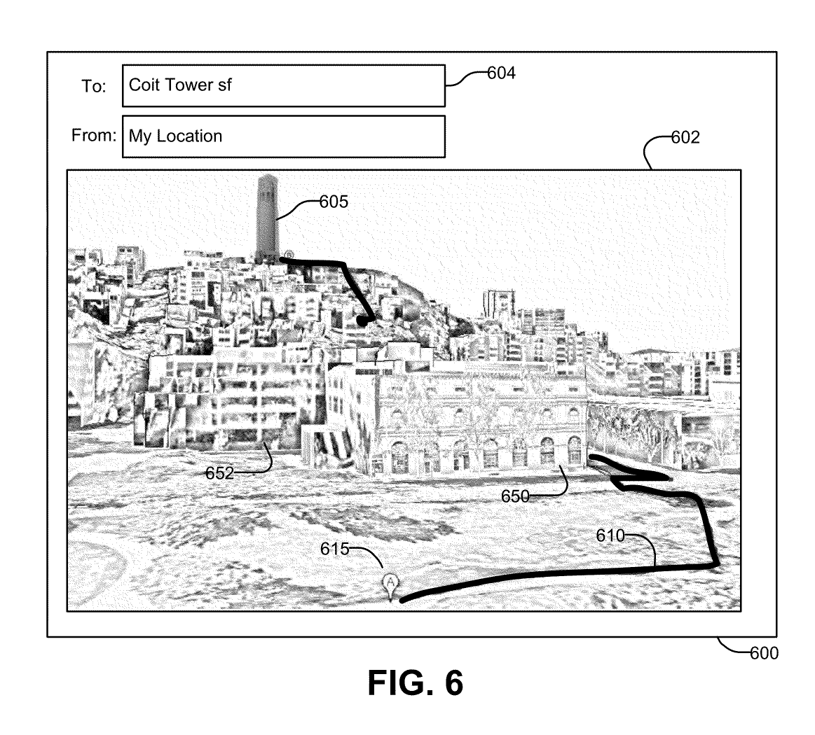

FIG. 6 is an example of a user interface 600 that includes a NPR, according to one embodiment. The interface includes a text box 604 for entering a query for directions to a particular geographic location. Here, the user is using a mobile phone to request directions from the user's current location to the “Coit Tower sf”. The rendering server 105 determines the location 615 of the user's mobile phone and identifies the Coit Tower 605 of San Francisco as the feature of interest. The rendering server 105 then generates an NPR image 602 by rendering the Coit Tower 605 in color and with darker shading. The remainder of the features in the image 602 are rendered in black and white and with no shading, resulting in a lower level of realism for these portions of the image 602.

The image 602 is also rendered from the point of view of the user's current location 615 to provide the user with an indication of how the Coit Tower 605 appears from the user's current position 615. Additionally, the image 602 also includes a highlighted route 610 that indicates how a user can reach the Coit tower 605 from the user's current location 615.

In another embodiment where the rendering server 105 is being used to generate a navigation route or to provide directions, features of the geo-data that are along the route may be rendered with greater emphasis than features that are not directly on the route. Emphasizing the features along a navigational route draws the user's attention to the route without losing the context of the features that surround the route. In this embodiment, a route is identified that leads from a point of origin to an intended destination. Portions of the geo-data that are located along the route are selected for rendering with a high level of emphasis. Other portions of the geo-data that are further from and not directly situated along the route are selected for rendering with a lower level of emphasis. For example, in FIG. 6, building 650 is located along the route 610, and could be rendered with parameter settings that result in a high level of visual emphasis. Building 652 is not directly located along the route 610, and could be rendered with parameter settings that result in a lower level of emphasis.

### Additional Configuration Considerations

The foregoing description of the embodiments has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Some embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosed embodiments are intended to be illustrative, but not limiting, of the scope of the invention, which is set forth in the following claims.

What is claimed is:

1. A computer implemented method of map rendering, comprising:
storing three dimensional (3D) geographic model data for a plurality of geographic features;
selecting a first portion of the 3D model data that represents a geographic feature of the plurality of geographic features;
selecting a second portion of the 3D model data from an area surrounding the first portion of the 3D model data;
generating a non-photorealistic rendering (NPR) by:
rendering the first portion of the 3D model data in a first rendering style according to a first set of rendering parameter settings; and
rendering the second portion of the 3D model data in a second rendering style according to a second set of rendering parameter settings, the second rendering style having a lower level of visual emphasis than the first rendering style; and
providing the NPR for display.

2. The method of claim 1, wherein the first rendering style is more realistic than the second rendering style.

3. The method of claim 2, wherein the first rendering style is a photorealistic rendering style and the second rendering style is a non-photorealistic rendering style.

4. The method of claim 1, wherein selecting a first portion of the geographic data comprises:
receiving a selection input;
identifying a geographic feature of the plurality of geographic features that corresponds to the selection input; and
selecting a first portion of the 3D model data that represents the identified geographic feature.

5. The method of claim 4, wherein the selection input is received from a client device, and providing the NPR for display comprises providing the NPR for display at a client device that provided the selection input.

6. The method of claim 4, wherein generating the NPR further comprises:
determining a location of a client device that provided the selection input,
wherein a point of view of the NPR is based on the location of the client device.

7. The method of claim 4, wherein generating the NPR further comprises:
determining an orientation of a client device that provided the selection input,
wherein a point of view of the NPR is based on the orientation of the client device.

8. The method of claim 1, wherein selecting a first portion of the geographic data comprises:
analyzing a user's prior search history; and
selecting a geographic feature of the plurality of geographic features based on the user's prior search history.

9. The method of claim 1, wherein selecting a first portion of the geographic data comprises:
determining a location of a client device; and
selecting a geographic feature of the plurality of geographic features based on the location of the client device.

10. The method of claim 1, wherein selecting a first portion of the geographic data comprises:
analyzing social information provided by a plurality of client devices; and
selecting a geographic feature of the plurality of geographic features based on the social information.

11. The method of claim 1, further comprising:
determining a time of day at a location of the geographic feature of the plurality of geographic features,
wherein the NPR is rendered to have an appearance based on the time of day at the geographic feature.

12. The method of claim 1, further comprising:
determining weather conditions at a location of the geographic feature of the plurality of geographic features,
wherein the NPR is rendered to have an appearance based on the weather conditions at the geographic feature.

13. The method of claim 1, further comprising:
selecting a transition portion of the 3D model data from between the first portion and second portion of the 3D model data; and
wherein generating the NPR further comprises rendering the transition portion of the 3D modeling data in a third rendering style with a third set of rendering parameter settings that creates a visual transition between the first portion and the second portion.

14. The method of claim 1, wherein generating a NPR comprises:
associating a first measure of visual emphasis with the first portion of the 3D model data;
determining a first set of rendering parameter settings for the first portion of the 3D model data according to the first measure of visual emphasis;
rendering the first portion of the 3D model data in a first rendering style according to the first measure of visual emphasis;
associating a second measure of visual emphasis with the second portion of the 3D model data, the second measure of visual emphasis being lower than the first measure of visual emphasis;
determining a second set of rendering parameter settings for the second portion of the 3D model data according to the second measure of visual emphasis; and
rendering the first portion of the 3D model data in a second rendering style according to the first set of rendering parameter settings.

15. A non-transitory computer-readable medium storing executable computer program code for map rendering, the code comprising code for:
storing three dimensional (3D) geographic model data for a plurality of geographic features;
selecting a first portion of the 3D model data that represents a geographic feature of the plurality of geographic features;
selecting a second portion of the 3D model data from an area surrounding the first portion of the 3D model data;
generating a non-photorealistic rendering (NPR) by:
rendering the first portion of the 3D model data in a first rendering style according to a first set of rendering parameter settings; and
rendering the second portion of the 3D model data in a second rendering style according to a second set of rendering parameter settings, the second rendering style having a lower level of visual emphasis than the first rendering style; and
providing the NPR for display.

16. The computer-readable medium of claim 15, wherein the first rendering style is more realistic than the second rendering style.

17. The computer-readable medium of claim 16, wherein the first rendering style is a photorealistic rendering style and the second rendering style is a non-photorealistic rendering style.

18. The computer-readable medium of claim 15, wherein selecting a first portion of the geographic data comprises:
receiving a selection input;
identifying a geographic feature of the plurality of geographic features that corresponds to the selection input; and
selecting a first portion of the 3D model data that represents the identified geographic feature.

19. The computer-readable medium of claim 18, wherein the selection input is received from a client device, and providing the NPR for display comprises providing the NPR for display at a client device that provided the selection input.

20. The computer-readable medium of claim 18, wherein generating the NPR further comprises:
determining a location of a client device that provided the selection input,
wherein a point of view of the NPR is based on the location of the client device.

21. The computer-readable medium of claim 18, wherein generating the NPR further comprises:
determining an orientation of a client device that provided the selection input,
wherein a point of view of the NPR is based on the orientation of the client device.

22. The computer-readable medium of claim 15, wherein selecting a first portion of the geographic data comprises:
analyzing a user's prior search history; and
selecting a geographic feature of the plurality of geographic features based on the user's prior search history.

23. The computer-readable medium of claim 15, wherein selecting a first portion of the geographic data comprises:
determining a location of a client device; and
selecting a geographic feature of the plurality of geographic features based on the location of the client device.

24. The computer-readable medium of claim 15, wherein selecting a first portion of the geographic data comprises:
analyzing social information provided by a plurality of client devices; and
selecting a geographic feature of the plurality of geographic features based on the social information.

25. The computer-readable medium of claim 15, wherein the code further comprises code for:
determining a time of day at a location of the geographic feature of the plurality of geographic features,
wherein the NPR is rendered to have an appearance based on the time of day at the geographic feature.

26. The computer-readable medium of claim 15, wherein the code further comprises code for:
determining weather conditions at a location of the geographic feature of the plurality of geographic features,
wherein the NPR is rendered to have an appearance based on the weather conditions at the geographic feature.

27. The computer-readable medium of claim 15, wherein the code further comprises code for:
selecting a transition portion of the 3D model data from between the first portion and second portion of the 3D model data; and
wherein generating the NPR further comprises rendering the transition portion of the 3D modeling data in a third rendering style with a third set of rendering parameter settings that creates a visual transition between the first portion and the second portion.

28. The computer-readable medium of claim 15, wherein generating a NPR comprises:
associating a first measure of visual emphasis with the first portion of the 3D model data;
determining a first set of rendering parameter settings for the first portion of the 3D model data according to the first measure of visual emphasis;
rendering the first portion of the 3D model data in a first rendering style according to the first measure of visual emphasis;
associating a second measure of visual emphasis with the second portion of the 3D model data, the second measure of visual emphasis being lower than the first measure of visual emphasis;
determining a second set of rendering parameter settings for the second portion of the 3D model data according to the second measure of visual emphasis; and
rendering the first portion of the 3D model data in a second rendering style according to the first set of rendering parameter settings.

29. A system for map rendering, comprising:
a non-transitory computer-readable medium storing executable program code, the code comprising code for:
storing three dimensional (3D) geographic model data for a plurality of geographic features;
selecting a first portion of the 3D model data that represents a geographic feature of the plurality of geographic features;
selecting a second portion of the 3D model data from an area surrounding the first portion of the 3D model data;
generating a non-photorealistic rendering (NPR) by:
rendering the first portion of the 3D model data in a first rendering style according to a first set of rendering parameter settings; and
rendering the second portion of the 3D model data in a second rendering style according to a second set of rendering parameter settings, the second rendering style having a lower level of visual emphasis than the first rendering style; and
providing the NPR for display; and
a processor for executing the code.

30. The system of claim 29, wherein the first rendering style is more realistic than the second rendering style.

31. The system of claim 30, wherein the first rendering style is a photorealistic rendering style and the second rendering style is a non-photorealistic rendering style.

32. The system of claim 29, wherein selecting a first portion of the geographic data comprises:
receiving a selection input;
identifying a geographic feature of the plurality of geographic features that corresponds to the selection input; and
selecting a first portion of the 3D model data that represents the identified geographic feature.

33. The system of claim 32, wherein the selection input is received from a client device, and providing the NPR for display comprises providing the NPR for display at a client device that provided the selection input.

34. The system of claim 32, wherein generating the NPR further comprises:
determining a location of a client device that provided the selection input,
wherein a point of view of the NPR is based on the location of the client device.

35. The system of claim 32, wherein generating the NPR further comprises:
determining an orientation of a client device that provided the selection input,
wherein a point of view of the NPR is based on the orientation of the client device.

36. The system of claim 29, wherein selecting a first portion of the geographic data comprises:
analyzing a user's prior search history; and
selecting a geographic feature of the plurality of geographic features based on the user's prior search history.

37. The system of claim 29, wherein selecting a first portion of the geographic data comprises:
determining a location of a client device; and
selecting a geographic feature of the plurality of geographic features based on the location of the client device.

38. The system of claim 29, wherein selecting a first portion of the geographic data comprises:
analyzing social information provided by a plurality of client devices; and
selecting a geographic feature of the plurality of geographic features based on the social information.

39. The system of claim 29, wherein the code further comprises code for:
determining a time of day at a location of the geographic feature of the plurality of geographic features,
wherein the NPR is rendered to have an appearance based on the time of day at the geographic feature.

40. The system of claim 29, wherein the code further comprises code for:
determining weather conditions at a location of the geographic feature of the plurality of geographic features,
wherein the NPR is rendered to have an appearance based on the weather conditions at the geographic feature.

41. The system of claim 29, wherein the code further comprises code for:
selecting a transition portion of the 3D model data from between the first portion and second portion of the 3D model data; and
wherein generating the NPR further comprises rendering the transition portion of the 3D modeling data in a third rendering style with a third set of rendering parameter settings that creates a visual transition between the first portion and the second portion.

42. The system of claim 29, wherein generating a NPR comprises:
associating a first measure of visual emphasis with the first portion of the 3D model data;
determining a first set of rendering parameter settings for the first portion of the 3D model data according to the first measure of visual emphasis;
rendering the first portion of the 3D model data in a first rendering style according to the first measure of visual emphasis;
associating a second measure of visual emphasis with the second portion of the 3D model data, the second measure of visual emphasis being lower than the first measure of visual emphasis;
determining a second set of rendering parameter settings for the second portion of the 3D model data according to the second measure of visual emphasis; and
rendering the first portion of the 3D model data in a second rendering style according to the first set of rendering parameter settings.
